(19) United States
(12) Patent Application Publication
(10) Pub. No.: US 2012/0154671 A1
(43) Pub. Date: Jun. 21, 2012

(54) LENS DRIVE DEVICE, AND CAMERA MODULE AND CELLULAR PHONE EQUIPPED WITH LENS DRIVE DEVICE

(75) Inventors: Suguru Ohishi, Tsuyama-shi (JP); Hiroshi Yamashita, Ichinomiya-shi (JP); Mituo Nakashima, Neyagawa-shi (JP); Kazuaki Someya, Gifu-ken (JP); Yuma Aoi, Ichinomiya-shi (JP); Satoru Ota, Osaka-shi (JP)

(73) Assignee: SANYO ELECTRIC CO., LTD., Moriguchi-shi, Osaka (JP)

(21) Appl. No.: 13/392,973

(22) PCT Filed: Sep. 1, 2010
(86) PCT No.: PCT/JP2010/064879

§ 371 Date: Feb. 28, 2012

(30) Foreign Application Priority Data
Sep. 3, 2009 (JP) 2009-203794

(51) Int. Cl. H04N 5/232; G03B 3/10; G02B 7/02

(52) U.S. Cl. 348/357; 359/823; 396/133; 348/E05.045

(57) ABSTRACT

A lens driving device accurately and smoothly moves a holder in an optical axis direction even when the distance between lower shaft end supporting portions differ from the distance between upper shaft end supporting holes. The cross-section, in a direction perpendicular to the optical axis direction, of at least one upper shaft end supporting hole 42 among the plurality of upper shaft end supporting holes 41 and 42 arranged in the cover is larger than the cross-section, in a direction perpendicular to the optical axis direction, of a corresponding sub-shaft 52 among the plurality of shafts.

### TECHNICAL FIELD

The present invention relates to a lens driving device that moves a lens module in an optical axis direction by guiding the lens module with a shaft arranged in the optical axis direction and to a camera module and cellular phone including a lens driving device.

### BACKGROUND ART

Nowadays, typical cellular phones include camera modules. Since it is difficult to perform manual focusing with such a camera module, an automatic focusing function (autofocus) has become an essential function. A lens driving device is used to perform autofocusing with the camera module. Further, cellular phones have become thinner and more compact. This has resulted in less space that can be provided for the lens driving device. Accordingly, as a structure that drives the lens unit of a lens driving device, a structure that drives a lens unit of a lens driving device adapts a moving magnet type linear driving technique such as that described in, for example, patent document 1. This structure adapting the moving magnet type linear driving technique is simpler than a structure using a stepping motor and can thus miniaturize the lens driving device. FIGS. 9 and 10 show one example of a lens driving device having such a structure that uses the moving magnet type linear driving technique.

As shown in FIGS. 9 and 10, magnets 120 are attached to a holder 110, which holds a lens unit 113. Coils 160 are attached to a base 130, which is fixed to a camera module main body. Current flows through the coils 160 to generate electromagnetic driving force. As a result, the magnets 120 attached to the holder 110 receive force in an optical axis direction. This moves the holder 110 in the optical axis direction of the lens unit 113.

More specifically, as shown in FIG. 9, a shaft 151 and a shaft 152 are held in the optical axis direction by a basal portion 131 of the base 130. More specifically, the shaft 151 is supported by a lower shaft end supporting portion 137, which is a recess formed in the basal portion 131, and an upper shaft end supporting hole 141, which is a through hole formed in a cover 140. In the same manner, the shaft 152 is supported by a lower shaft end supporting portion 138, which is a recess formed in the basal portion 131, and an upper shaft end supporting hole 142, which is a through hole formed in the cover 140. The holder 110 includes a shaft hole 115, which is a through hole extending in the optical axis direction in correspondence with the shaft 151, and a shaft hole 116, which is a through hole extending in the optical axis direction in correspondence with the shaft 152. The shaft 151 is inserted through the shaft hole 115, and the shaft 152 is inserted through the shaft hole 116. This holds the holder 110 in a manner slidable in the optical axis direction relative to the shaft 151 and the shaft 152. When the magnets 120 attached to the holders 110 receive force in the optical axis direction, the holder 110 is guided by the shaft hole 115 and the shaft hole 116 and moved in the optical axis direction.

### PRIOR ART DOCUMENT

Patent Document 1: Japanese Laid-Open Patent Publication No. 2008-185749

### DISCLOSURE OF THE INVENTION

### Problems that are to be Solved by the Invention

The base 130 and the cover 140 are discrete members. Thus, complete alignment is difficult. For example, as shown in FIG. 11, when the center of the upper shaft end supporting hole 141 is deviated from an extended line of the center of the lower shaft end supporting portion 137 in the optical axis direction and the center position of the upper shaft end supporting hole 142 is deviated from an extended line of the center of the lower shaft end supporting portion 138 in the optical axis direction, the shaft 151 and the shaft 152 are both supported in a state deviated from the optical axis direction. In this manner, when the shaft 151 and the shaft 152 are both supported in a state deviated from the optical axis direction, it is difficult for the holder 110 to move in the optical axis direction. Further, even when movement occurs, the movement will not be smooth.

Accordingly, for instance, by using a structure that allows for correction of the coupling position when coupling the cover 140 to the base 130, for example, the center of the upper shaft end supporting hole 141 can be aligned with the extended line of the center of the lower shaft end supporting portion 137 in the optical axis direction. However, as shown in the drawing, when the distance Lb between the lower shaft end supporting portion 137 and the lower shaft end supporting portion 138 differs from a distance Lc between the upper shaft end supporting hole 141 and the upper shaft end supporting hole 142, the center of the upper shaft end supporting hole 141 cannot be aligned with the extended line of the center of the lower shaft end supporting portion 137 in the optical axis direction when, at the same time, aligning the center of the upper shaft end supporting hole 142 with the extension of the center of the lower shaft end supporting portion 138 in the optical axis direction. Thus, when the distance Lb between the lower shaft end supporting portion 137 and the lower shaft end supporting portion 138 differs from the distance Lc between the upper shaft end supporting hole 141 and the upper shaft end supporting hole 142, at least one of the shaft 151 and the shaft 152 is supported in a state tilted relative to the optical axis direction. When the shaft 151 and the shaft 152 are supported in a state tilted relative to the optical axis direction, the holder 110 may not smoothly move in the optical axis direction. In a severe case, the holder 110 may not be movable.

In light of the situation described above, the present invention provides a lens driving device that moves a holder more accurately and smoothly in the optical axis direction than the prior art even if the distance between the lower shaft end supporting portions differs from the distance between the upper shaft end supporting holes. It is also an object to provide a camera module including such a lens driving device and a cellular phone including the camera module.

### Means for Solving the Problem

A lens driving device according to the present invention includes a holder that holds a lens unit. A plurality of cylindrical shafts guide movement of the holder in an optical axis direction of the holder and include axes directed in the optical axis direction of the lens unit. A basal portion is fixed to an apparatus. A plurality of lower shaft end supporting portions support lower ends of the plurality of shafts and are arranged in the basal portion. A cover covers and protects the lens unit, the holder, the plurality of shafts, and the basal portion. A plurality of upper shaft end supporting holes are arranged in the cover. The plurality of upper shaft end supporting holes are through holes into which upper ends of the plurality of shafts can be inserted to support the upper ends of the plurality of shafts. A cross-section, perpendicular to the optical axis direction, of at least one upper shaft end supporting hole among the plurality of upper shaft end supporting holes is larger than a cross-section, perpendicular to the optical axis direction, of a corresponding shaft among the plurality of shafts.

In the above structure, the cross-section, perpendicular to the optical axis direction, of at least one upper shaft end supporting hole among the plurality of upper shaft end supporting holes is larger than a cross-section, perpendicular to the optical axis direction, of a corresponding shaft among the plurality of shafts. Accordingly, even when the center positions of the upper shaft end supporting holes are deviated from the extensions of the center positions of lower shaft end supporting portions in the optical axis direction, the directions in which the shafts extend are prevented from being tilted relative to the optical axis direction by absorbing or reducing positional deviation with the difference in the cross-sections.

A lens driving device according to the present invention includes a holder that holds a lens unit. A plurality of cylindrical shafts guide movement of the holder in an optical axis direction of the holder and include axes directed in the optical axis direction of the lens unit. A basal portion is fixed to an apparatus. A plurality of lower shaft end supporting portions are arranged in the basal. The plurality of lower shaft end supporting portions support lower ends of the plurality of shafts. A shaft holder includes a plurality of upper shaft end supporting holes that are through holes into which upper ends of the plurality of shafts can be inserted to support the upper ends of the plurality of shafts. A cover covers and protects the lens unit, the holder, the plurality of shafts, the shaft holder, and the basal portion. A cross-section, perpendicular to the optical axis direction, of at least one upper shaft end supporting hole among the plurality of upper shaft end supporting holes is larger than a cross-section, perpendicular to the optical axis direction, of a corresponding shaft among the plurality of shafts.

In the above structure, the shaft holder includes a plurality of upper shaft end supporting holes that are similar to those of the cover are arranged in the shaft holder. This prevents the shaft from being supported in a state in which its extension is tilted relative to the optical axis direction.

Preferably, the lens driving device according to the present invention further includes a shaft fixing member that fixes the shaft to the upper shaft end supporting hole. The at least one upper shaft end supporting hole among the upper shaft end supporting holes supports the upper end of the shaft with the shaft fixing member.

In the above structure, at least one upper shaft end supporting portion among the upper shaft end supporting hole supports the upper end of the shaft with the shaft fixing member. Accordingly, as described above, even when the cross-section, perpendicular to the optical axis direction, of at least one of the upper shaft end supporting holes is larger than the cross-section, perpendicular to the optical axis direction, of the corresponding shaft, the shaft fixing member ensures that the shaft is fixed to the upper shaft end supporting hole.

Preferably, in the lens driving device according to the present invention, the shaft fixing member includes an adhesive movement restriction portion that restricts downward movement of an adhesive applied to the shaft fixing member.

The shaft fixing member includes an adhesive movement restriction portion that restricts downward movement of the adhesive applied to the shaft fixing member. Thus, even when using an adhesive to fix the shaft fixing member to the upper shaft end supporting hole, the adhesive applied to the shaft fixing member is prevented from moving downward and adversely affecting the lens driving device. Examples of the adhesive movement restriction portion include a groove and a projection that collect adhesive that flows and moves downward.

A lens driving device according to the present invention includes a holder that holds a lens unit. A plurality of cylindrical shafts guide movement of the holder in an optical axis direction and include axes directed in the optical axis direction of the lens unit. A basal portion is fixed to an apparatus. A plurality of lower shaft end supporting portions arranged in the basal portion. The plurality of lower shaft end supporting portions support lower ends of the plurality of shafts. A cover covers and protects the lens unit, the holder, the plurality of shafts, and the basal portion. A plurality of upper shaft end supporting holes are arranged in the cover. The plurality of upper shaft end supporting holes are through holes into which upper ends of the plurality of shafts can be inserted to support the upper ends of the plurality of shafts. The plurality of lower end supporting portions are recesses into which the lower ends of the shafts are inserted. A cross-section, perpendicular to the optical axis direction, of at least one lower shaft end supporting portion among the plurality of lower shaft end supporting portions is larger than a cross-section, perpendicular to the optical axis direction, of a corresponding shaft among the plurality of shafts.

In the above structure, the lower shaft end supporting portions are recesses into which the lower ends of the shafts are inserted. Further, the cross-section, perpendicular to the optical axis direction, of at least one lower shaft end supporting portion among the plurality of lower shaft end supporting portions is larger than a cross-section, perpendicular to the optical axis direction, of a corresponding shaft among the plurality of shafts. Accordingly, even when the center position of the upper shaft end supporting hole is deviated from the extension of the center position of the lower shaft end supporting portion in the optical axis direction, absorption of the positional deviation with the difference in the cross-sections prevents the shaft from being supported in a state in which its extension is tilted relative to the optical axis direction.

Preferably, in the lens driving device according to the present invention, the cross-section, perpendicular to the optical axis direction, of at least one lower shaft end supporting portion among the plurality of lower shaft end supporting portions has a shape that is an ellipse of which major axis extends in a direction connecting two opposing lower shaft end supporting portions among the plurality of lower shaft end supporting portions. Further, the cross-section, perpendicular to the optical axis direction, of a corresponding shaft among the plurality of shafts has a shape that is a circle with a smaller diameter than the ellipse.

In the above structure, the cross-section, perpendicular to the optical axis direction, of at least one lower shaft end supporting portion among the plurality of lower shaft end supporting portions has a shape that is an ellipse. The cross-section, perpendicular to the optical axis direction, of the corresponding shaft has a shape that is a circle with a smaller diameter than the ellipse. Accordingly, even when the center position of the upper shaft end supporting hole deviate in the major axis direction of the ellipse from the extension of the center position of the lower shaft end supporting portion in the optical axis direction, the shaft is prevented from being supported in a state in which its extension is tilted relative to the optical axis direction. Further, the ellipse has a major axis extending in a direction connecting two opposing lower shaft end supporting portions among the plurality of lower shaft end supporting portions. Thus, even when the shaft is supported such that its extension is tilted relative to the optical direction, the other shaft suppresses adverse effects. This lowers the possibility of the holder being tilted by a tilted shaft.

A camera module according to the present invention includes the above lens driving device. The lens driving device described above is a lens driving device that smoothes the movement of the lens module and has high driving accuracy. Accordingly, the camera module that includes the lens driving device is highly accurate.

A cellular phone according to the present invention includes the above camera module. The camera module is compact and highly accurate. The camera module is thus preferable for use as a camera module for a cellular phone.

### EFFECT OF THE INVENTION

The present invention provides a lens driving device in which a holder is moved in an optical axis direction more smoothly and accurately compared to the prior art even when the distance between the lower shaft end supporting portions differs from the distance between the upper shaft end supporting holes. Further, the present invention provides a camera module including such a lens driving device and a cellular phone including such a camera module.

### BRIEF DESCRIPTION OF THE DRAWINGS

FIG. 1 is a schematic diagram showing one embodiment of a cellular phone according to the present invention in a state in which the cellular phone is closed.

FIG. 2 schematically shows one embodiment of the cellular phone according to the present invention in a state in which the cellular phone is open, where FIG. 2(a) is a perspective view showing an inner surface and FIG. 2(b) is a perspective view showing a rear surface.

FIG. 3 is a schematic diagram showing the structure of a camera module in the embodiment of the cellular phone according to the present invention.

FIG. 4 is an exploded perspective view of a lens driving device of a camera module in the embodiment of the cellular phone according to the present invention.

FIG. 5 is a cross-sectional view taken along an optical axis direction of the lens driving device in the embodiment of the cellular phone according to the present invention.

FIG. 6 shows the embodiment of the cellular phone according to the present invention, where FIG. 6(a) is a partial exploded perspective view showing the lens driving device and FIG. 6(b) is a partial enlarged cross-sectional view showing the vicinity of a shaft.

FIG. 7 shows a second embodiment of a cellular phone according to the present invention, where FIG. 7(a) is a plan view showing a base of a lens driving device and FIG. 7(b) is a partial enlarged plan view showing the vicinity of a shaft.

FIG. 8 is a cross-sectional view taken along an optical axis direction of the lens driving device in the second embodiment of the cellular phone according to the present invention.

FIG. 9 is a perspective view showing a lens driving device of the prior art in a state in which a cover is removed.

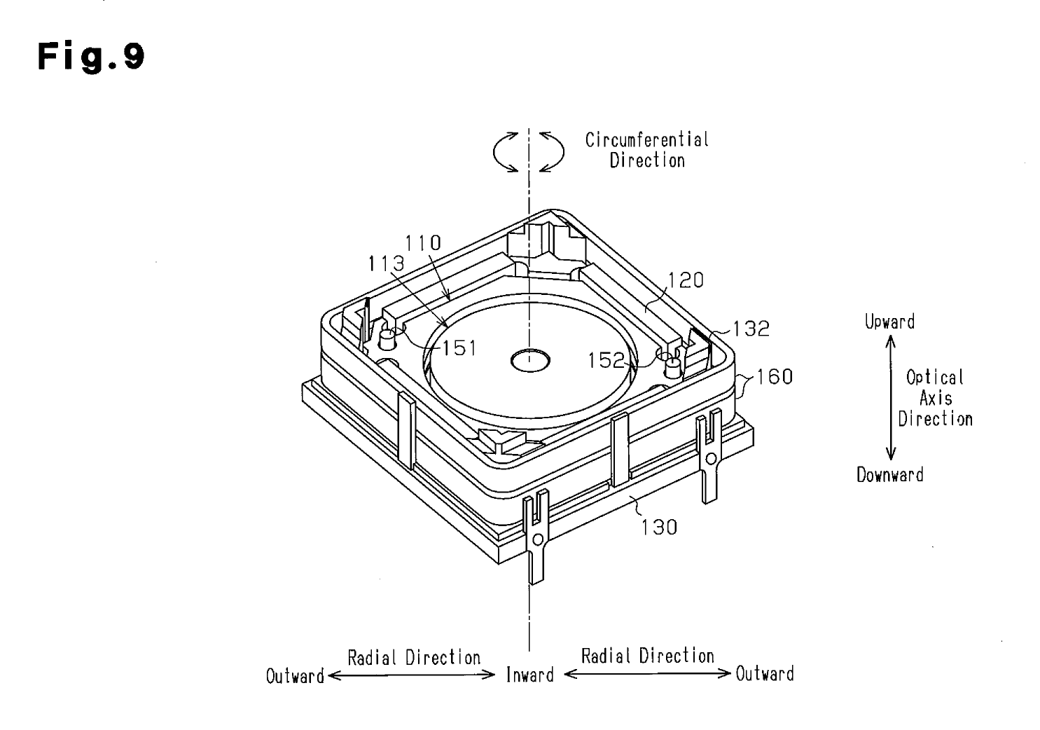

FIG. 10 is an exploded perspective view showing the lens driving device of the prior art.

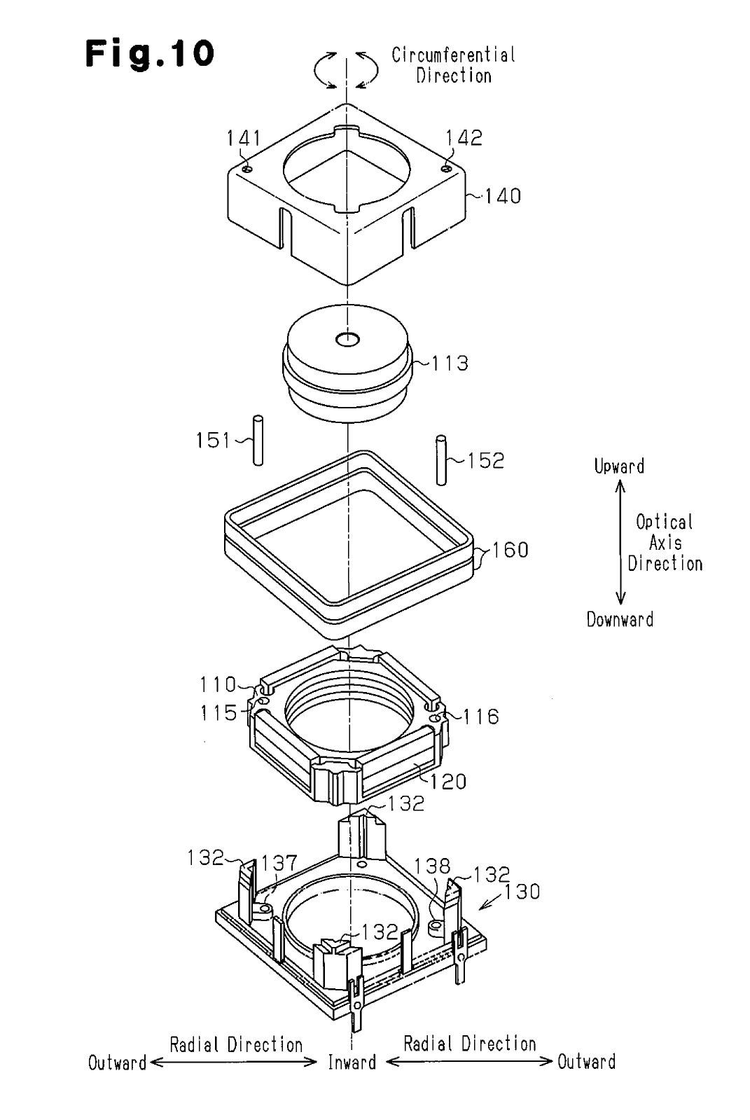

FIG. 11 is a partial cross-sectional view showing the lens driving device of the prior art.

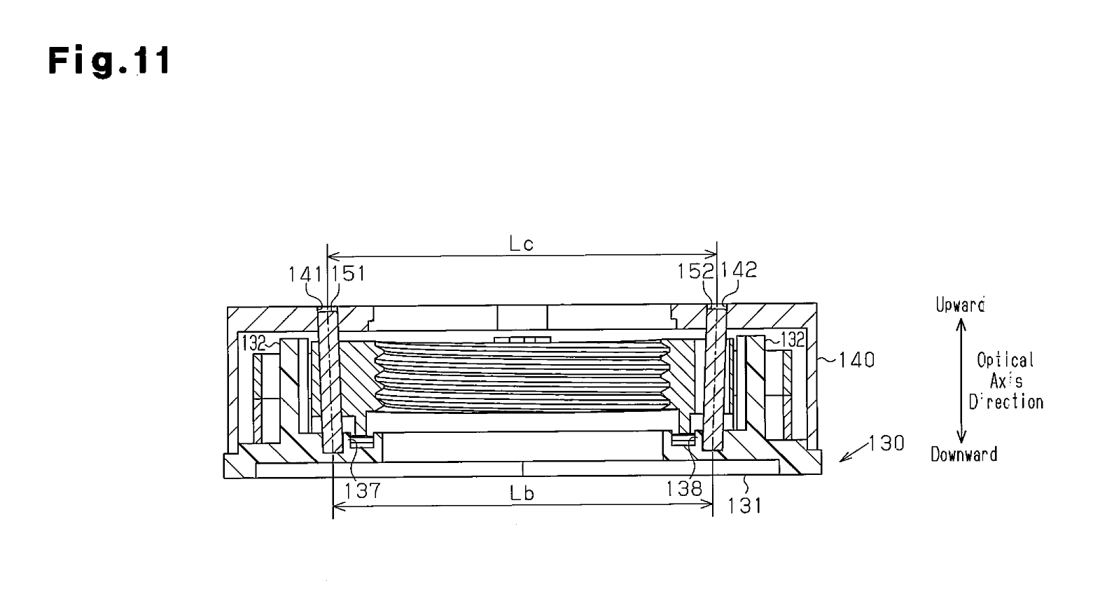

FIG. 12 is an exploded perspective view showing a lens driving device of a camera module arranged in a third embodiment of a cellular phone according to the present invention.

### EMBODIMENTS OF THE INVENTION

### First Embodiment

One embodiment of a cellular phone according to the present invention will now be described with reference to the drawings.

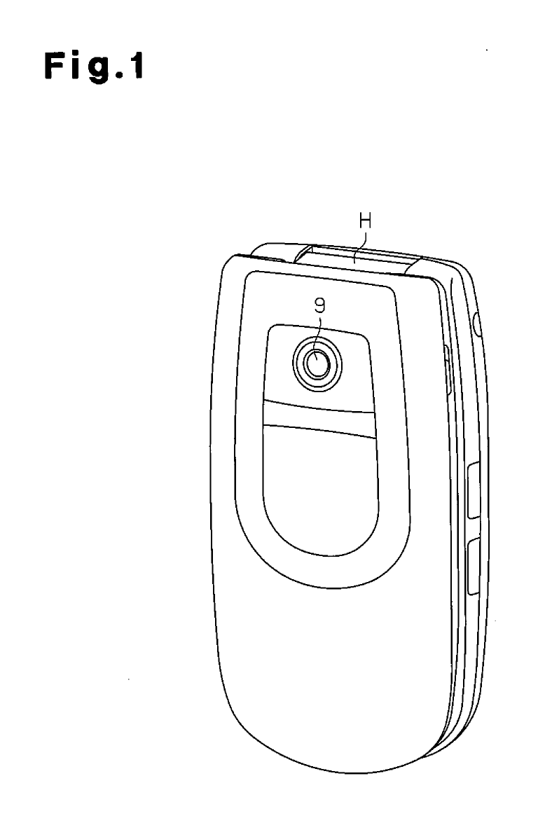

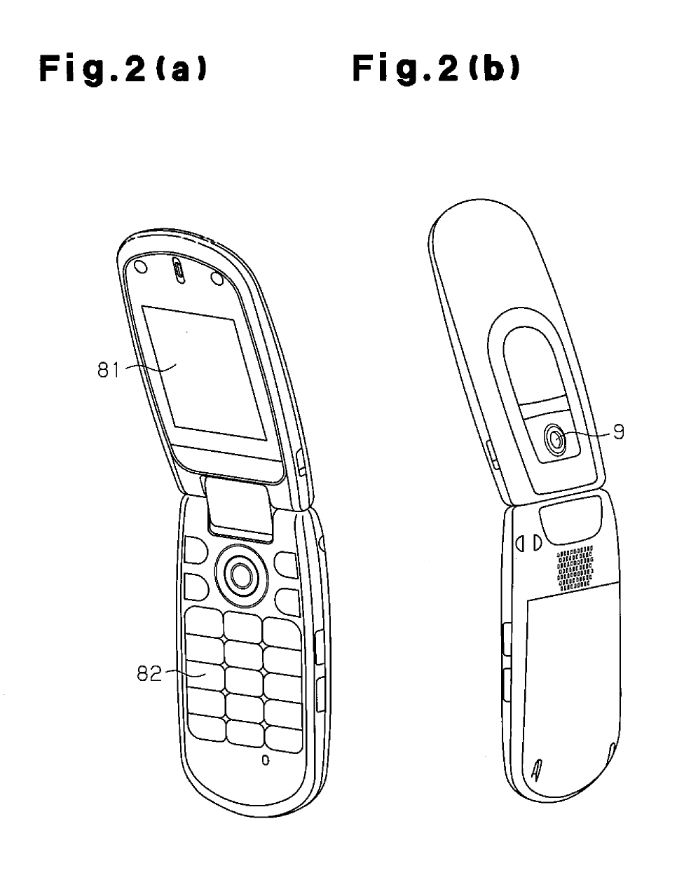

As shown in FIG. 1, the cellular phone is a mobile phone that is folded about a hinge H. FIG. 1 is a view showing the folded state, in which a cover glass 9, which is part of a camera module, is exposed from the front surface. FIG. 2(a) is a view showing the cellular phone in an open state so that a display unit 81 and an operation unit 82 face toward the front. FIG. 2(b) is a view showing the cellular phone in an open state from the rear. To take a picture of a subject, a photographer directs the cover glass 9 towards the subject that is to be captured with the cellular phone in an open state and releases the shutter by operating the operation unit 82 while checking the image on the display unit 81.

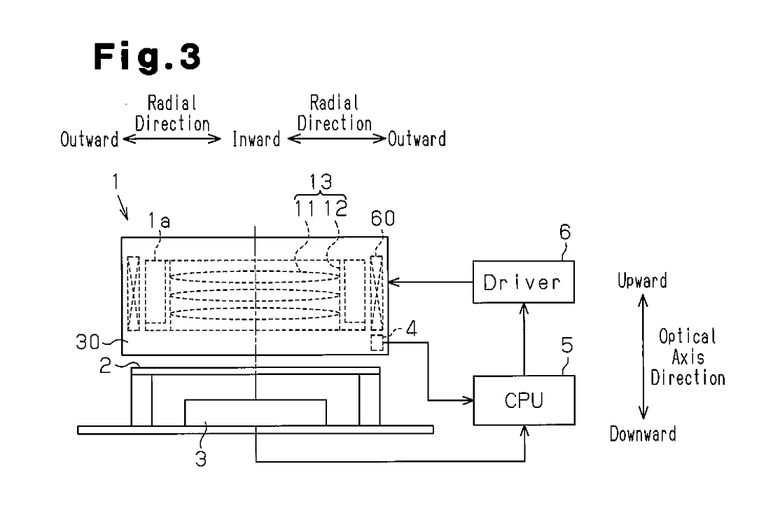

The structure of the camera module when arranging a lens driving device 1 of the present embodiment in a camera will now be described with reference to FIG. 3.

As shown in FIG. 3, a filter 2 and an image sensor 3 are arranged at a side of the lens driving device 1 that is closer to a base 30. A Hall element 4, which serves as a position detection element, is arranged on the base 30. The position of a lens module 1a is performed based on a signal from the Hall element 4.

During a focusing operation, a central processing unit (CPU) 5 controls a driver 6 to move the lens module 1a upward in an optical axis direction from a home position to a preset position. Here, the Hall element 4 sends a position detection signal to the CPU 5. At the same time, the CPU 5 processes the signal input from the image sensor 3 to acquire a contrast value of a captured image. This operation is repeated to obtain the position of the lens module 1a at which the contrast value becomes most satisfactory as a focus position.

Then, the CPU 5 drives the lens module 1a to the focus position. Specifically, the CPU 5 monitors the signal from the Hall element 4 and drives the lens module 1a until the signal from the Hall element 4 corresponds to the focus position. This operation moves the lens module 1a to the focus position.

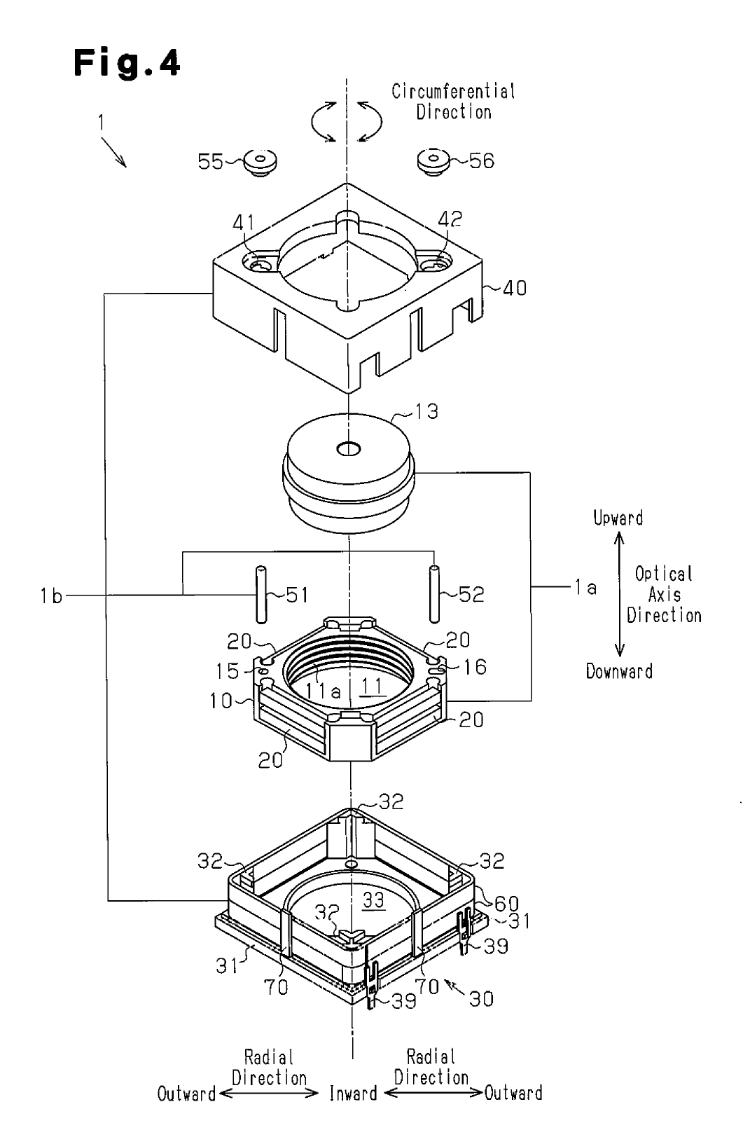

The entire structure of the lens driving device 1, which drives the lens module 1a, will now be described in detail with reference to FIG. 4. The lens driving device 1 includes the lens module 1a, which is movable in the optical axis direction, and a fixed body 1b, which applies driving force to the lens module 1a and is fixed to an apparatus in which the lens driving device 1 is installed. Autofocusing is performed by moving the lens module 1a in the optical axis direction with the lens driving device 1. The lens driving device 1 of the present embodiment is a square having 8.5 mm sides as viewed from above in the optical axis direction, and the lens driving device 1 has a height in the optical axis direction that is approximately 3 mm.

Referring also to FIG. 3, the lens module 1a includes a lens unit 13 formed by a plurality of optical lenses 11 and, a lens barrel 12 that holds the plurality of optical lenses 11, a holder 10 that holds the lens unit 13 and is formed from resin, and a plurality of magnets 20 fixed to the holder 10. In the present embodiment, four magnets 20 are fixed to the holder 10 and arranged outward in a radial direction from the lens unit 13 surrounding the lens unit 13 in a circumferential direction and separated from one another by a fixed distance in the circumferential direction. The holder 10 is formed by injection molding a resin material. In this case, the magnets 20 are attached in advance to a mold that forms the holder 10 so that the holder is molded integrally with the magnets during injection molding. Such a manufacturing process increases the bonding strength of the magnets 20 and the holder 10 as compared to when joining the magnets 20 and the holder 10 with an adhesive. This also eliminates the process of attaching the magnets 20 and reduces costs.

The holder 10 includes a main shaft hole 15, which is a through hole extending in the optical axis direction for insertion of one of two cylindrical shafts, namely, a main shaft 51, and a sub-shaft hole 16, which is a through hole extending in the optical axis direction for insertion of a sub-shaft 52. The main shaft 51 and the sub-shaft 52 are arranged in the optical axis direction of the lens unit 13. Thus, the lens module 1a can be moved in the optical axis direction by moving the holder 10 in a state in which an inner circumferential surface of the main shaft hole 15 slides in contact with an outer circumferential surface of the main shaft 51 and an inner circumferential surface of the sub-shaft hole 16 slides in contact with an outer circumferential surface of the sub-shaft 52.

The fixed body 1b includes the base 30 and cover 40, which form an outer frame of the lens driving device 1, a shaft, which is fixed to the base 30 and includes the main shaft 51 and the sub-shaft 52 that guide the movement in the optical axis direction of the holder 10, and coils 60, which form a magnetic field when current is applied. Magnetic plates 70, which are rectangular plate-shaped magnetic members formed from magnetic steel plates, are fixed to the base 30 outward in the radial direction from the coils 60.

The base 30 includes a basal portion 31, which forms the lower surface of the outer frame of the lens driving device 1, and posts 32, which extend in the optical axis direction from the basal portion 31. The basal portion 31 is square when viewed from above in the optical axis direction. The posts 32 are arranged at the four corners of the basal portion 31. An opening 33, which is a circular through hole, is formed in a central position of the basal portion 31.

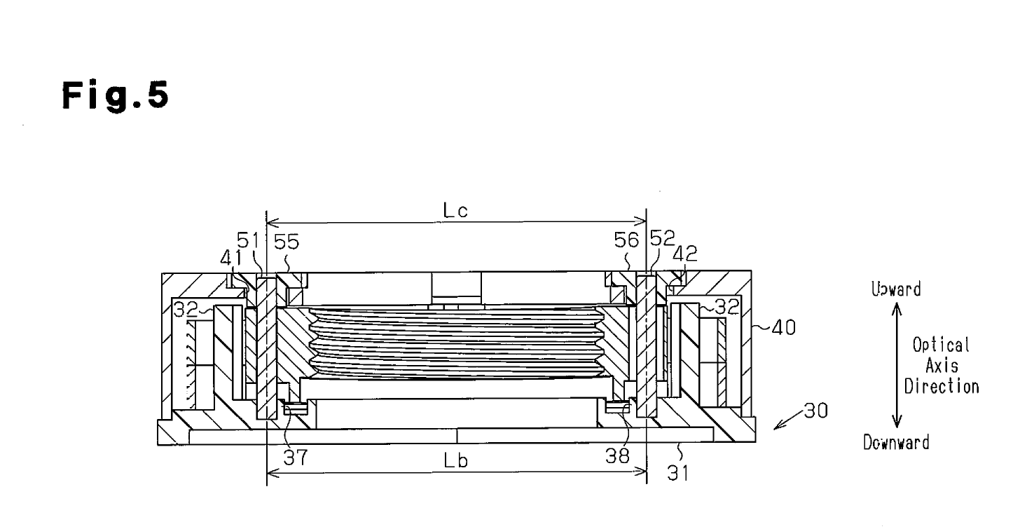

As shown in FIG. 5, the base 30 further includes a lower shaft end supporting portion 37, which is a recess for supporting a lower side in the optical axis direction (hereinafter simply referred to as “lower end”) of the main shaft 51, the axis of which extends in the optical axis direction of the lens unit 13. In the same manner, a lower shaft end supporting portion 38, which is a recess for supporting a lower end in the optical axis direction of the sub-shaft 52, the axis of which extends in the optical axis direction of the lens unit 13, is also provided.

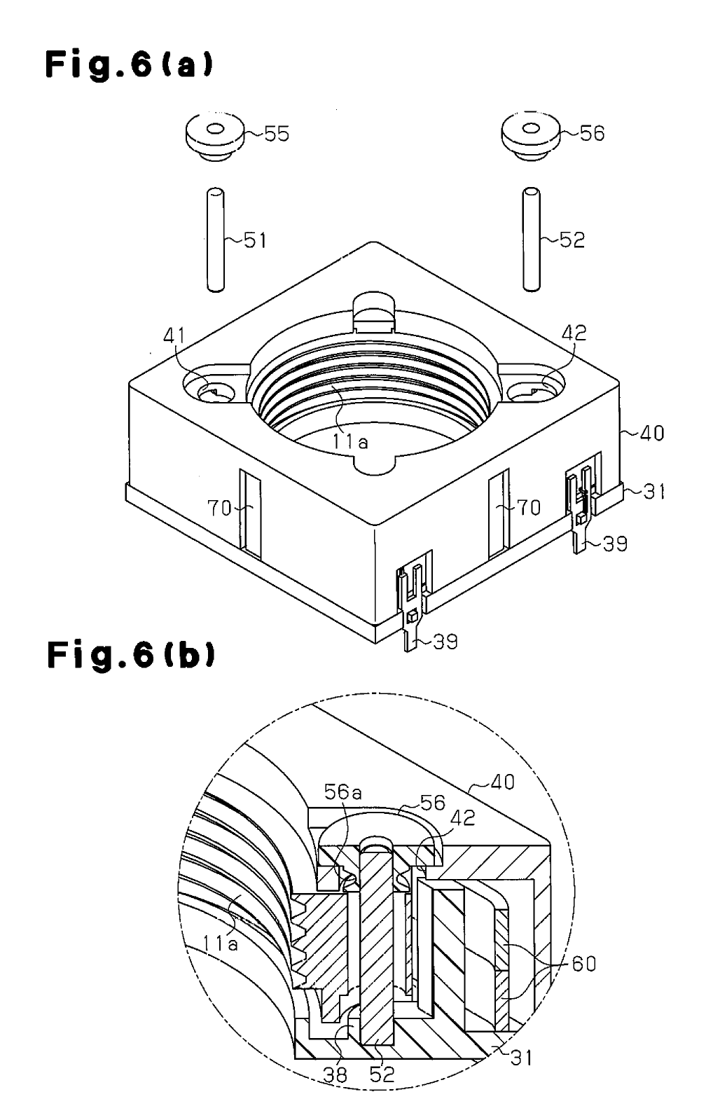

As shown in FIG. 6(a), the cover 40, which defines the outer side surfaces and upper surface of the lens driving device 1, is attached to the base 30 surrounding the radially outer side of the coils 60. Further, a upper shaft end supporting hole 41, which is a through hole for supporting an upper side in the optical axis direction (hereinafter simply referred to as “upper end”) of the main shaft 51, is arranged in the upper surface of the cover 40. A upper shaft end supporting hole 42, which is a through hole for supporting an upper end of the sub-shaft 52, is also provided.

The present embodiment has a feature in which the cross-sections, perpendicular to the optical axis direction, of the upper shaft end supporting hole 41 and the upper shaft end supporting hole 42 are larger than the cross-sections, perpendicular to the axial direction, of the corresponding main shaft 51 and sub-shaft 52. Thus, even if the center positions of the upper shaft end supporting hole 41 and the upper shaft end supporting hole 42 deviate from extensions of the lower shaft end supporting portion 37 and the lower shaft end supporting portion 38 in the optical axis direction, the difference in the cross-section absorbs or reduces the positional deviation. This prevents the shaft extension direction from being tilted with respect to the optical axis direction.

Further, in the present embodiment, a shaft fixing member 55 and a shaft fixing member 56 fixes the upper ends of the main shaft 51 and the sub-shaft 52 to the upper shaft end supporting hole 41 and the upper shaft end supporting hole 42, respectively. The upper end of the main shaft 51 is fixed in the upper shaft end supporting hole 41 by the shaft fixing member 55, and the upper end of the sub-shaft 52 is fixed in the upper shaft end supporting hole 42 by the shaft fixing member 56.

As shown in FIGS. 6(a) and 6(b), the shaft fixing member 55 and the shaft fixing member 56 each include a cylindrical portion, to which the upper end of the main shaft 51 or the sub-shaft 52 can be inserted, and a disk-like portion, which seals the upper end of the cylindrical portion. As shown in FIG. 6(b), an adhesive movement restriction portion 56a, which is a groove that restricts downward movement of an adhesive applied to the shaft fixing member 56, is formed on an outer circumferential surface of the cylindrical portion of the shaft fixing member 56. Although not shown in the drawings because of the same structure, the outer circumferential surface of the cylindrical portion of the shaft fixing member 55 also includes an adhesive movement restriction portion that restricts downward movement of the adhesive applied to the shaft fixing member 55.

Pits, which are recessed downward and circular, are arranged near the upper shaft end supporting hole 41 and the upper shaft end supporting hole 42 in the upper surface of the cover 40. The depth of each pit is substantially the same as the thickness of the shaft fixing member 56. Thus, the height of the lens driving device 1 is not greater than the prior art even after attaching the shaft fixing member 56. Further, the diameter of the pit is greater than the diameter of the disk-like portion of the shaft fixing member 56. Thus, the fixing position of the fixing member 56 is not limited by the pit.

The main shaft 51 and the sub-shaft 52 of the lens driving device 1 can be arranged in the optical axis direction, for example, in the following manner. First, the base 30 is fixed to a jig or the like (not shown). Then, the lens module 1a, which includes the holder 10, and the cover 40 are coupled. Here, the lower shaft end supporting portion 37, the main shaft hole 15, and the upper shaft end supporting hole 41 are aligned in the optical axis direction. Further, the lower shaft end supporting portion 38, the sub-shaft hole 16, and the upper shaft end supporting hole 42 are aligned in the optical axis direction. Next, a jig or the like (not shown) is used to insert the main shaft 51 from the upper side in the optical axis direction in the order of the upper shaft end supporting hole 41, the main shaft hole 15, and the lower shaft end supporting portion 37. This accurately supports the lower end of the main shaft 51 in the optical axis direction with the lower shaft end supporting portion 37. The cross-section, perpendicular to the optical axis direction, of the upper shaft end supporting hole 41 is larger than the cross-section, perpendicular to the optical axis direction, of the main shaft 51. Thus, as long as the main shaft 51 extends in the optical axis direction with the lower shaft end supporting portion 37 serving as a support point, the main shaft 51 will not be tilted by the upper shaft end supporting hole 41. In the same manner, the sub-shaft 52 is inserted from the upper side in the optical axis direction in the order of the upper shaft end supporting hole 42, the sub-shaft hole 16, and the lower shaft end supporting portion 38. This accurately supports the lower end of the sub-shaft 52 in the optical axis direction with the lower shaft end supporting portion 38. The cross-section, perpendicular to the optical axis direction, of the upper shaft end supporting hole 42 is larger than the cross-section, perpendicular to the optical axis direction, of the sub-shaft 52. Thus, as long as the sub-shaft 52 extends in the optical axis direction with the lower shaft end supporting portion 38 serving as a support point, the sub-shaft 52 will not be tilted by the upper shaft end supporting hole 42. Even if the distance Lb between the lower shaft end supporting portion 37 and the lower shaft end supporting portion 38 differs from the distance Lc between the upper shaft end supporting hole 41 and the upper shaft end supporting hole 42, the main shaft 51 and the sub-shaft 52 are both supported in the optical axis direction as long as the difference in the distance can be absorbed by the difference in the cross-section of the upper shaft end supporting hole 41 and cross-section of the main shaft 51 and by the difference in the cross-section of the upper shaft end supporting hole 42 and the cross-section of the sub-shaft 52.

Then, the shaft fixing member 55 is attached by inserting the upper end of the main shaft 51 into the cylindrical portion of the shaft fixing member 55 and adhering the shaft fixing member 55 to the upper shaft end supporting hole 41 so that the upper end of the main shaft 51 is supported by the upper shaft end supporting hole 41 through the shaft fixing member 55. With regard to the sub-shaft 52, in the same manner as with the main shaft 51, the upper end of the sub-shaft 52 is supported by the upper shaft end supporting hole 42 through the shaft fixing member 56. The main shaft 51 and the sub-shaft 52 can both be arranged in the optical axis direction. Here, even if the adhesive, which adheres the shaft fixing member 55 and the shaft fixing member 56, flows along the cylindrical portions of the shaft fixing member 55 and moves downward, the adhesive collects in the adhesive movement restriction portion. This prevents the adhesive from moving further downward and falling into the lens driving device 1.

The lens driving device 1 of the present embodiment has the advantages described below.

(1) In the present embodiment, the cross-sections, perpendicular to the optical axis direction, of two upper shaft end supporting holes 41 and 42 are larger than the cross-sections, perpendicular to the optical axis direction, of the corresponding main shaft 51 and sub-shaft 52. Accordingly, even when the center positions of the upper shaft end supporting holes 41 and 42 are deviated from extensions of the center positions of the lower shaft end supporting portions 37 and 38 in the optical axis direction, the directions in which the main shaft 51 and the sub-shaft 52 extend are prevented from being tilted relative to the optical axis direction by absorbing or reducing positional deviation with the difference in the cross-sections.

(2) In the present embodiment, the two upper shaft end supporting holes 41 and 42 support the upper ends of the shafts with the shaft fixing members 55 and 56. Accordingly, as described above, even when the cross-sections, perpendicular to the optical axis direction, of the upper shaft end supporting holes 41 and 42 are larger than the cross-sections, perpendicular to the optical axis direction, of the corresponding main shaft 51 and the sub-shaft 52, the shaft fixing members 55 and 56 ensure that the main shaft 51 and the sub-shaft 52 are fixed to the upper shaft end supporting holes 41 and 42.

(3) The adhesive movement restriction portions of the shaft fixing members 55 and 56 restrict downward movement of the adhesive applied to the shaft fixing members 55 and 56. Accordingly, even when using an adhesive to fix the shaft fixing members 55 and 56 respectively to the upper shaft end supporting holes 41 and 42, the adhesive applied to the shaft fixing members 55 and 56 is prevented from moving downward and adversely affecting the lens driving device 1.

(4) The camera module of the present embodiment is mounted with the lens driving device 1 described above. The lens driving device 1 is a lens driving device that smoothens movement of the lens module and is thus a lens driving device having a high driving accuracy. Accordingly, the camera module that includes the lens driving device is a camera module having high accuracy.

(5) The cellular phone of the present embodiment includes the camera module described above. The camera module is compact and highly accurate and is thus preferable for use as a camera module for a cellular phone.

### Second Embodiment

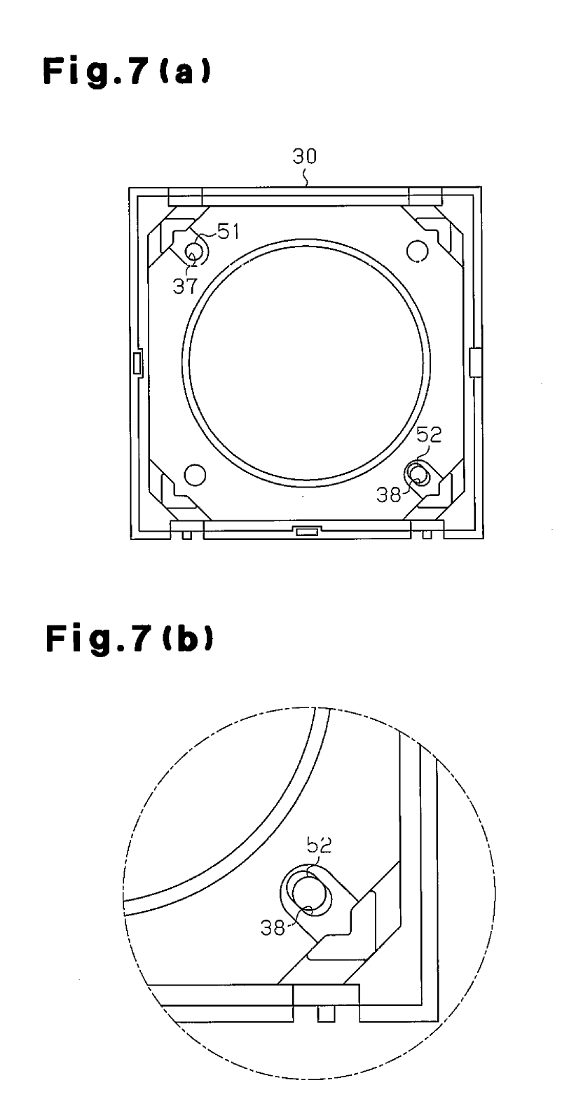

A second embodiment of a cellular phone according to the present invention will now be described with reference to FIG. 7. In the second embodiment, only the structure of the cover 40 and the base 30 are changed from the first embodiment. Thus, similar parts will not be described in detail.

In the second embodiment, the upper ends of the main shaft 51 and the sub-shaft 52 are directly fixed to the upper shaft end supporting hole 41 and the upper shaft end supporting hole 42, respectively. The shaft fixing member 55 is not used.

The feature is in that the cross-section, perpendicular to the optical axis direction, of at least one of a plurality of lower shaft end supporting portions is larger than the cross-section, perpendicular to the optical axis direction, of a corresponding one of a plurality of shafts. Specifically, the feature is in that the cross-section, perpendicular to the optical axis direction, of at least one of a plurality of lower shaft end supporting portions has the shape of an ellipse, and the cross-section, perpendicular to the optical axis direction, of the corresponding shaft has the shape of a circle with a smaller diameter than the ellipse.

More specifically, as shown in FIGS. 7(a) and 7(b), the cross-section, perpendicular to the optical axis direction, of the lower shaft end supporting portion 38, which corresponds to the sub-shaft 52, has the shape of an ellipse. The minor axis of the ellipse is substantially equal to the diameter of the sub-shaft 52, and the major axis of the ellipse is greater than the diameter of the sub-shaft 52.

Accordingly, the cross-section, perpendicular to the optical axis direction, of the lower shaft end supporting portion 38 is larger than the cross-section, perpendicular to the optical axis direction, of the sub-shaft 52.

The major axis of the ellipse extends in a direction that is the same as the direction of a line connecting the lower shaft end supporting portion 37 and the lower shaft end supporting portion 38, which face toward each other. Specifically, this is the radial direction in the present example. Thus, for example, even when the sub-shaft 52 corresponding to the lower shaft end supporting portion 38 is tilted relative to the optical axis direction, the tilting direction is toward the main shaft 51. Accordingly, even when the sub-shaft 52 is tilted in the radial direction, as long as the main shaft 51 is accurately fixed in the optical axis direction, the influence of the tilting is suppressed by the main shaft 51, and tilting of the lens module 1a is suppressed. If the major axis of the oval were to be the direction perpendicular to the line connecting the lower shaft end supporting portion 37 and the lower shaft end supporting portion 38, that is, the circumferential direction, the sub-shaft 52 would also tilt in the circumferential direction. Hence, it would become difficult to reduce the influence of the tilting with the main shaft 51. This would result in tilting of the lens module 1a.

The main shaft 51 and the sub-shaft 52 of the lens driving device 1 are arranged in the optical axis direction in the following manner, for example. First, the base 30 is fixed to a jig or the like (not shown). Then, the lens module 1a, which includes the holder 10, and the cover 40 are coupled. Here, the lower shaft end supporting portion 37, the main shaft hole 15, and the upper shaft end supporting hole 41 are aligned in the optical axis direction. Further, the lower shaft end supporting portion 38, the sub-shaft hole 16, and the upper shaft end supporting hole 42 are aligned in the optical axis direction. Next, a jig or the like (not shown) is used to insert the main shaft 51 from the upper side in the optical axis direction in the order of the upper shaft end supporting hole 41, the main shaft hole 15, and the lower shaft end supporting portion 37. Further, the lower end of the main shaft 51 is accurately supported in the optical axis direction by the lower shaft end supporting portion 37. The cross-section, perpendicular to the optical axis direction, of the upper shaft end supporting hole 41 is substantially equal to the cross-section, perpendicular to the optical axis direction, of the main shaft 51. Thus, the upper end of the main shaft 51 is directly fixed to and supported by the upper shaft end supporting hole 41. Further, the cross-section, perpendicular to the optical axis direction, of the lower shaft end supporting portion 37 is substantially equal to the cross-section, perpendicular to the optical axis direction, of the main shaft 51. Thus, the center of the upper shaft end supporting hole 41 is aligned with the center of the lower shaft end supporting portion 37 in the optical axis direction. This accurately supports the main shaft in the optical axis direction.

The sub-shaft 52 can also be arranged in the optical axis direction by inserting the sub-shaft 52 in the same manner as the main shaft 51 in the optical axis direction using the center position of the upper shaft end supporting hole 42 as a reference. Here, the cross-section, perpendicular to the optical axis direction, of the upper shaft end supporting hole 42 is substantially equal to the cross-section, perpendicular to the optical axis direction, of the sub-shaft 52. Thus, the upper end of the sub-shaft 52 is directly fixed to and supported by the upper shaft end supporting hole 42. Further, the cross-section, perpendicular to the optical axis direction, of the lower shaft end supporting portion 38 is larger than the cross-section, perpendicular to the optical axis direction, of the sub-shaft 52. Thus, even when the center of the upper shaft end supporting hole 42 and the center of the lower shaft end supporting portion 38 cannot be aligned in the optical axis direction, as long as the difference of the centers can be absorbed by the difference of the cross-sections, the sub-shaft can be accurately supported in the optical axis direction.

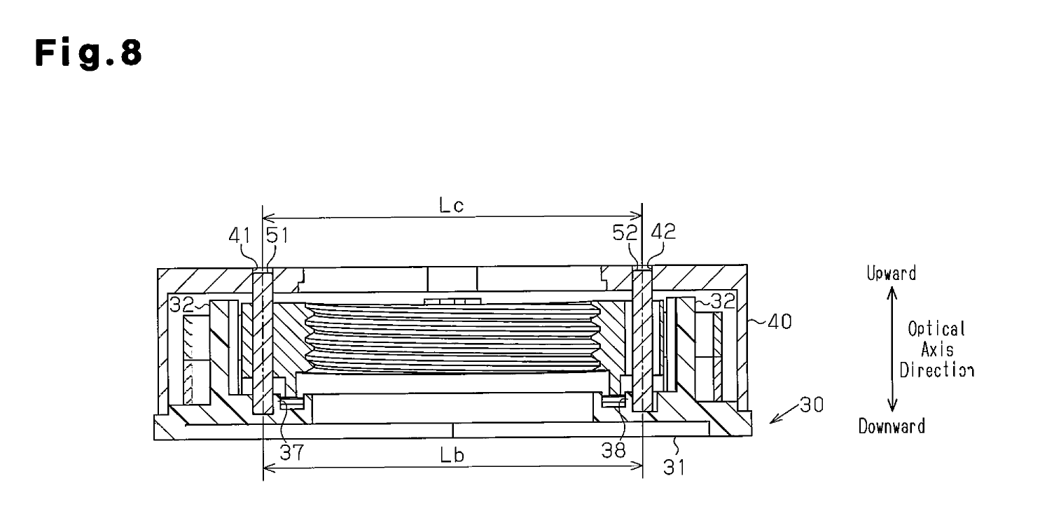

As shown in FIG. 8, even when the distance Lb between the centers of the lower shaft end supporting portion 37 and the lower shaft end supporting portion 38 differs from the distance Lc between the centers of the upper shaft end supporting hole 41 and the upper shaft end supporting hole 42, as long as the difference in the distance can be absorbed by the difference in the cross-section of the lower shaft end supporting portion 38 and the cross-section of the sub-shaft 52, the main shaft 51 and the sub-shaft 52 can both be supported in the optical axis direction.

The cellular phone of the above embodiment has the advantages described below.

(1) In the second embodiment, among the two lower shaft end supporting portions 37 and 38, the cross-section, perpendicular to the optical axis direction, of the lower shaft end supporting portion 38 is larger than the cross-section, perpendicular to the optical axis direction, of the corresponding sub-shaft 52. Accordingly, even when the center position of the upper shaft end supporting hole is deviated from the extension of the center position of the lower shaft end supporting portion in the optical axis direction, absorption or reduction of the positional deviation with the difference in the cross-sections prevents the shaft from being supported in a state in which its extension is tilted relative to the optical axis direction.

(2) In the second embodiment, the cross-section, perpendicular to the optical axis direction, of the lower shaft end supporting portion 38 is larger than the cross-section, perpendicular to the optical axis direction, of the corresponding sub-shaft 52. Accordingly, even when the center position of the upper shaft end supporting hole 42 is deviated from an extension of the center position of the lower shaft end supporting portion 38 in the optical axis direction, the absorption of the positional deviation with the difference in the cross-sections prevents the sub-shaft 52 from being supported in a state in which its extension is tilted relative to the optical axis direction.

(3) In the second embodiment, the cross-section, perpendicular to the optical axis direction, of the lower shaft end supporting portion 38 has the shape of an ellipse. The cross-section, perpendicular to the optical axis direction, of the corresponding sub-shaft 52 has the shape of a circle with a smaller diameter than the ellipse. Accordingly, even when the center position of the upper shaft end supporting hole 42 is deviated in the major axis direction of the ellipse from the extension of the center position of the lower shaft end supporting portion 38 in the optical axis direction, the shaft is prevented from being supported in a state in which its extension is tilted relative to the optical axis direction.

(4) In the ellipse, the major axis direction is the direction connecting the two lower shaft end supporting portions. Thus, even when the sub-shaft 52 is supported such that its extension is tilted relative to the sub-shaft 52, the main shaft 51 suppresses adverse effects. This lowers the possibility of the holder 10 being tilted by the tilted sub-shaft 52.

(5) The camera module of the second embodiment includes the lens driving device 1 described above. The lens driving device 1 described above is a lens driving device that smoothens the movement of the lens module and has a high driving accuracy. Thus, the camera module that includes the lens driving device is highly accurate.

(6) The cellular phone of the second embodiment includes the camera module described above. The camera module is compact and highly accurate. The camera module is thus preferable for use as a camera module for a cellular phone.

### Third Embodiment

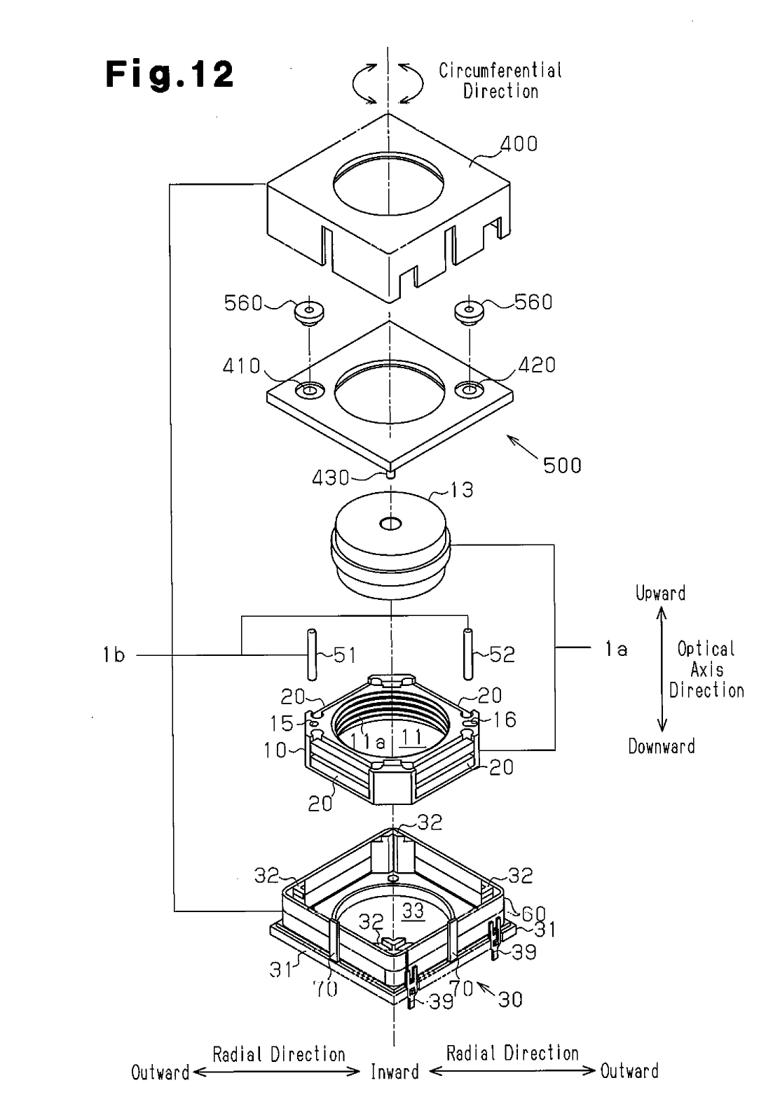

A third embodiment of a cellular phone according to the present invention will now be described with reference to FIG. 12. The third embodiment adds a shaft holder 500, and only the structure of the cover 40 and the base 30 are changed from the first embodiment. Thus, similar parts will not be described in detail.

In the third embodiment, the upper shaft end supporting hole 41 and the upper shaft end supporting hole 42 are eliminated from the cover 40 of the first embodiment. The newly added shaft holder 500 includes an upper shaft end supporting hole 410, an upper shaft end supporting hole 420, and a contact portion 430 used to position the base 30.

The same advantages as the first embodiment are obtained by arranging the upper shaft end supporting hole 410 and the upper shaft end supporting hole 420 in the shaft holder 500. Further, the upper shaft end supporting holes 410 and 420 are formed in a member having a planar shape such as the shaft holder 500. Thus, the upper shaft end supporting holes 41 and 42 do not need to be formed in a member having a complicated shape such as the cover 40 of the first embodiment. This facilitates manufacturing.

The third embodiment may be applied to the second embodiment.

The present embodiment may be modified as described below.

In the first embodiment, the cross-sections, perpendicular to the optical axis direction, of the upper shaft end supporting hole 41 and the upper shaft end supporting hole 42 are larger than the cross-sections, perpendicular to the axial direction, of the corresponding main shaft 51 and the sub-shaft 52 but may have other forms. For example, the cross-section, perpendicular to the optical axis direction, of the upper shaft end supporting hole 42 may be larger than the cross-section, perpendicular to the axial direction, of the sub-shaft 52, and the upper shaft end supporting hole 41 may have the same area as the cross-section perpendicular to the axial direction of the main shaft 51. In this case, the difference in the cross-sections of the upper shaft end supporting hole 42 and the sub-shaft 52 absorb positional deviation. This prevents the main shaft 51 and the sub-shaft 52 from being supported in a state in which their extensions are tilted relative to the optical axis direction. As a result, the same advantages as the third embodiment are obtained.

In the first embodiment, the two upper shaft end supporting holes 41 and 42 support the upper ends of the shafts with the shaft fixing members 55 and 56 but may have other forms. For example, the fixing may be achieved without using one of the shaft fixing members 55 and 56. When the upper shaft end supporting hole 41 has the same area as the cross-section perpendicular to the axial direction of the main shaft 51 like in the above modification, the upper end of the main shaft 51 may be directly supported by the upper shaft end supporting hole 41 without using the shaft fixing member 56. In this case, the number of components can be reduced and the coupling step of the shaft fixing member 55 can be eliminated. This lowers costs. As a result, the same advantages as the third embodiment are obtained with the same structure.

Further, the shaft fixing member 56 may be eliminated if the sub-shaft 52 can be supported by the upper shaft end supporting hole 42 by other means. In this case, the number of components can be reduced and the coupling step of the shaft fixing member 56 can be eliminated. This further lowers costs.

In the first embodiment, the adhesive movement restriction portion, which restricts downward movement of the adhesive applied to the shaft fixing members 55 and 56, is a groove arranged on the outer circumferential surface of the cylindrical portion of the shaft fixing member 56 but may have another structure. As long as downward movement of the adhesive applied to the shaft fixing members 55 and 56 can be restricted, the adhesive movement restriction portion may be a projection, a step, or a rough surface arranged on the outer circumferential surface of the cylindrical portion. Further, when the downward movement of the adhesive is not a problem, the adhesive movement restriction portion can be eliminated. This structure may also be applied to the shaft fixing members 550 and 560 of the third embodiment and obtain the same advantages.

In the second embodiment, the cross-section, perpendicular to the optical axis direction, of the lower shaft end supporting portion 38 may have the shape of an ellipse, and the cross-section, perpendicular to the optical axis direction, of the corresponding sub-shaft 52 may have the shape of a circle having a smaller diameter than the ellipse. However, other forms may be employed. As long as the difference between the cross-section, perpendicular to the optical axis direction, of the lower shaft end supporting portion 38 and the cross-section, perpendicular to the optical axis direction, of the sub-shaft 52 absorbs positional deviation and thereby prevents a shaft from being supported in a state in which its extension is tilted relative to the optical axis direction, the shapes of the cross-sections are not limited as long as they are in correspondence with each other.

In the second embodiment, the cross-section, perpendicular to the optical axis direction, of the lower shaft end supporting portion 38 is larger than the cross-section, perpendicular to the optical axis direction, of the corresponding sub-shaft 52 but may have another form. For example, as long as the main shaft 51 is supported in the optical axis direction by the upper shaft end supporting hole 41, the cross-section, perpendicular to the optical axis direction, of the lower shaft end supporting portion 37 may be larger than the cross-section, perpendicular to the optical axis direction, of the corresponding main shaft 51. In this case, even when the center of the upper shaft end supporting hole 41 is deviated from the center of the lower shaft end supporting portion 37 in the optical axis direction, the main shaft 51 can be supported in the optical axis direction.

In the above embodiment, only one sub-shaft 52 is used. However, a plurality of sub-shafts can be used. An increase in the number of sub-shafts prevents tilting of the lens module 1a relative to the optical axis direction. In this case, with respect to the cross-sections, perpendicular to the optical direction, of the sub-shafts, the cross-sections, perpendicular to the optical axis direction, of the corresponding upper shaft end supporting holes are enlarged or the cross-sections, perpendicular to the optical direction, of the corresponding lower shaft end supporting holes are enlarged. This also allows the main shaft 51 and the sub-shafts 52 to be supported in the optical axis direction even when the center of the upper shaft end supporting hole is deviated from the position of the center of the lower shaft end supporting portion in the optical axis direction.

In the above embodiment, the lens driving device is installed in the camera module but may be used in other forms. For example, the lens driving device may be installed in other optical devices, such as a telescope, a microscope, a binocular, and the like to add an autofocusing function to the optical device.

In the above embodiment, the camera module is installed in a cellular phone but may be used in other forms. The camera module may be installed in a compact digital camera, a digital single-lens reflex camera, or a camera for silver salt photography. Further, the camera module may be installed in a digital video camera for recording moving pictures or a film camera.

### DESCRIPTION OF REFERENCE CHARACTERS

1: lens driving device
1a: lens module
1b: fixed body
2: filter
3: image sensor
4: Hall element
6: driver
9: cover glass
10: holder
11: optical lens
12: lens barrel
13: lens unit
15: main shaft hole
16: sub-shaft hole
20: magnet
30: base
31: basal portion
32: post
33: opening
37: lower shaft end supporting portion
38: lower shaft end supporting portion
40: cover
400: cover
41: upper shaft end supporting hole
42: upper shaft end supporting hole
410: upper shaft end supporting hole
420: upper shaft end supporting hole
430: contact portion
500: shaft holder
51: main shaft
52: sub-shaft
55, 56: shaft fixing member
550, 560: shaft fixing member
56a: adhesive movement restriction portion
60: coil
70: magnetic plate
81: display unit
82: operation unit
110: holder
113: lens unit
115: shaft hole
116: shaft hole
120: magnet
130: base
131: basal portion
137: lower shaft end supporting portion
138: lower shaft end supporting portion
140: cover
141: upper shaft end supporting hole
142: upper shaft end supporting hole
151: shaft
152: shaft
160: coil
H: hinge

1. A lens driving device comprising:
a holder that holds a lens unit;
a plurality of cylindrical shafts that guide movement of the holder in an optical axis direction of the holder and include axes directed in the optical axis direction of the lens unit;
a basal portion fixed to an apparatus;
a plurality of lower shaft end supporting portions that support lower ends of the plurality of shafts and are arranged in the basal portion;
a cover that covers and protects the lens unit, the holder, the plurality of shafts, and the basal portion; and
a plurality of upper shaft end supporting holes arranged in the cover, wherein the plurality of upper shaft end supporting holes are through holes into which upper ends of the plurality of shafts can be inserted to support the upper ends of the plurality of shafts;
wherein a cross-section, perpendicular to the optical axis direction, of at least one upper shaft end supporting hole among the plurality of upper shaft end supporting holes is larger than a cross-section, perpendicular to the optical axis direction, of a corresponding shaft among the plurality of shafts.

2. A lens driving device comprising:
a holder that holds a lens unit;
a plurality of cylindrical shafts that guide movement of the holder in an optical axis direction of the holder and include axes directed in the optical axis direction of the lens unit;
a basal portion fixed to an apparatus;
a plurality of lower shaft end supporting portions arranged in the basal portion, wherein the plurality of lower shaft end supporting portions support lower ends of the plurality of shafts;
a shaft holder including a plurality of upper shaft end supporting holes that are through holes into which upper ends of the plurality of shafts can be inserted to support the upper ends of the plurality of shafts; and
a cover that covers and protects the lens unit, the holder, the plurality of shafts, the shaft holder, and the basal portion;
wherein a cross-section, perpendicular to the optical axis direction, of at least one upper shaft end supporting hole among the plurality of upper shaft end supporting holes is larger than a cross-section, perpendicular to the optical axis direction, of a corresponding shaft among the plurality of shafts.

3. The lens driving device according to claim 1, further comprising a shaft fixing member that fixes the shaft to the upper shaft end supporting hole,
wherein the at least one upper shaft end supporting hole among the upper shaft end supporting holes supports the upper end of the shaft with the shaft fixing member.

4. The lens driving device according to claim 3, wherein the shaft fixing member includes an adhesive movement restriction portion that restricts downward movement of an adhesive applied to the shaft fixing member.

5. A lens driving device comprising:
a holder that holds a lens unit;
a plurality of cylindrical shafts that guide movement of the holder in an optical axis direction and include axes directed in the optical axis direction of the lens unit;
a basal portion fixed to an apparatus;
a plurality of lower shaft end supporting portions arranged in the basal portion, wherein the plurality of lower shaft end supporting portions support lower ends of the plurality of shafts;
a cover that covers and protects the lens unit, the holder, the plurality of shafts, and the basal portion; and
a plurality of upper shaft end supporting holes arranged in the cover, wherein the plurality of upper shaft end supporting holes are through holes into which upper ends of the plurality of shafts can be inserted to support the upper ends of the plurality of shafts, wherein
the plurality of lower end supporting portions are recesses into which the lower ends of the shafts are inserted, and
a cross-section, perpendicular to the optical axis direction, of at least one lower shaft end supporting portion among the plurality of lower shaft end supporting portions is larger than a cross-section, perpendicular to the optical axis direction, of a corresponding shaft among the plurality of shafts.

6. A lens driving device comprising:
a holder that holds a lens unit;
a plurality of cylindrical shafts that guide movement of the holder in an optical axis direction and include axes directed in the optical axis direction of the lens unit;
a basal portion fixed to an apparatus;
a plurality of lower shaft end supporting portions, arranged in the basal portion, wherein the plurality of lower shaft end supporting portions support lower ends of the plurality of shafts;
a shaft holder including a plurality of upper shaft end supporting holes that are through holes into which upper ends of the plurality of shafts can be inserted to support the upper ends of the plurality of shafts; and
a cover for covering and protecting the lens unit, the holder, the plurality of shafts, the shaft holder, and the basal portion, wherein
the plurality of lower end supporting portions are recesses into which the lower ends of the shafts are inserted, and
a cross-section, perpendicular to the optical axis direction, of at least one lower shaft end supporting portion among the plurality of lower shaft end supporting portions is larger than a cross-section, perpendicular to the optical axis direction, of a corresponding shaft among the plurality of shafts.

7. The lens driving device according to claim 5, wherein
the cross-section, perpendicular to the optical axis direction, of at least one lower shaft end supporting portion among the plurality of lower shaft end supporting portions has a shape that is an ellipse of which major axis extends in a direction connecting two opposing lower shaft end supporting portions among the plurality of lower shaft end supporting portions, and
the cross-section, perpendicular to the optical axis direction, of a corresponding shaft among the plurality of shafts has a shape that is a circle with a smaller diameter than the ellipse.

8. A camera module including the lens driving device according to claim 1.

9. A cellular phone including the camera module according to claim 8.

10. The lens driving device according to claim 2, further comprising a shaft fixing member that fixes the shaft to the upper shaft end supporting hole,
wherein the at least one upper shaft end supporting hole among the upper shaft end supporting holes supports the upper end of the shaft with the shaft fixing member.

11. The lens driving device according to claim 10, wherein the shaft fixing member includes an adhesive movement restriction portion that restricts downward movement of an adhesive applied to the shaft fixing member.

12. The lens driving device according to claim 6, wherein
the cross-section, perpendicular to the optical axis direction, of at least one lower shaft end supporting portion among the plurality of lower shaft end supporting portions has a shape that is an ellipse of which major axis extends in a direction connecting two opposing lower shaft end supporting portions among the plurality of lower shaft end supporting portions, and
the cross-section, perpendicular to the optical axis direction, of a corresponding shaft among the plurality of shafts has a shape that is a circle with a smaller diameter than the ellipse.

13. A camera module including the lens driving device according to claim 12.

14. A cellular phone including the camera module according to claim 13.

15. A camera module including the lens driving device according to claim 2.

16. A cellular phone including the camera module according to claim 15.

17. A camera module including the lens driving device according to claim 3.

18. A cellular phone including the camera module according to claim 17.

19. A camera module including the lens driving device according to claim 4.

20. A cellular phone including the camera module according to claim 19.
